(19) United States
(12) Patent Application Publication
(10) Pub. No.: US 2022/0265054 A1
(43) Pub. Date: Aug. 25, 2022

(54) PELVIC TILT DETECTING CHAIR

(71) Applicant: Guo-Yuan WU, Taipei (TW)

(72) Inventor: Guo-Yuan WU, Taipei (TW)

(21) Appl. No.: 17/671,153

(22) Filed: Feb. 14, 2022

(30) Foreign Application Priority Data
Feb. 20, 2021 (TW) 110105937

(51) Int. Cl. A47C 9/00; A47C 3/40; G01C 9/06

(52) U.S. Cl. CPC A47C 9/005; A47C 3/40; G01C 9/06

(57) ABSTRACT

A pelvic tilt detecting chair is provided to a user to sit and configured to detect a pelvic angle of the pelvis of the user in sitting position. The pelvic tilt detecting chair comprises a base, a supporting component, a carrying component and a detector. The base has a horizontal surface. The supporting component comprises a first end connected to the base and a second end. The carrying component is moveably configured and comprises an installing surface coupled to the second end and a chair surface configured to contact the pelvis of the user. The chair surface and the horizontal surface form a tilt angle when the user sits on the carrying component. The detector stores a tilt angle threshold value and is configured to the carrying component to detect the tilt angle. The detector generates a warning signal when the tilt angle is not matched up with the tilt angle threshold value.

The present application is based on, and claims priority from, Taiwan application number 110105937, filed on Feb. 20, 2021, the disclosure of which is hereby incorporated by reference herein in its entirety.

### BACKGROUND OF THE INVENTION

### Field of the Invention

The present invention relates to a chair, and in particular, to a pelvic tilt detecting chair that can automatically detect and alert whether the pelvis is excessively tilted.

### Description of the Prior Art

In modern society, people often perform many activities in a sitting position, such as eating, taking transportation, watching TV, working and studying. Generally, when a user sits on a chair, the ischium of the pelvis of the user contacts and leans against the chair surface of the chair. When the user sits for a long time, the user may change the sitting position due to pain or soreness of the sciatic bones. Since the chair surface of most chairs is a fixed plane, when the user changes the sitting posture, the user may lean against the chair surface of the chair with the sacrum. At this time, the pelvis of the user may be tilted forward or backward with the change of the sitting posture, thereby resulting in poor sitting posture.

When the sacrum is attached to the chair in the sitting position, the muscles of the waist and abdomen do not need to exert effort. Therefore, the user often ignores the problem of poor sitting posture due to comfort.

However, when the user sits for a long time with the pelvis tilted forward or backward for a long time, it is easy to cause problems such as neck pain, back pain or hip discomfort. If you do not improve your sitting posture for a long time, it is more likely to increase the risk of kyphosis, body arthritis, lumbar disc herniation, structural changes of organs, spinal deformation, cervical spine spurs and other diseases.

Therefore, it is necessary to develop a chair that can alert the user of excessive pelvic tilt and poor sitting posture, so as to solve the problems of the prior art.

### SUMMARY OF THE INVENTION

In view of this, the present invention provides a pelvic tilt detecting chair to solve the problems of the prior art.

In an embodiment, a pelvic tilt detecting chair is configured for a user to sit thereon and to detect a pelvic angle of the pelvis of the user in sitting position. The pelvic tilt detecting chair comprises a base, a supporting component, a carrying component and a detector. The base comprises a horizontal surface. The supporting component comprises a first end and a second end opposite to the first end. The first end is connected to the base. The carrying component is moveably disposed on the supporting component and is configured to carry the pelvis of the user. The carrying component comprises an installing surface and a chair surface opposite to the installing surface. The installing surface is coupled to the second end of the supporting component, causing the carrying component to swing with the second end as a fulcrum. The chair surface is configured to contact the pelvis, and a tilt angle is formed between the chair surface and the horizontal surface of the base when the user sits on the carry component. Wherein, the tilt angle corresponds to the pelvic angle of the user. The detector is disposed on the carrying component, the detector is configured to detect the tilt angle and store a tilt angle threshold value, wherein the detector generates a warning signal when the tilt angle does not match up with the tilt angle threshold value.

Wherein, the chair surface of the carrying component comprises a first groove and a second groove, and the pelvis of the user comprises a left ischial tuberosity and a right ischial tuberosity. When the user sits on the carrying component, the first groove and the second groove respectively accommodate the left ischial tuberosity and the right ischial tuberosity.

Further, the second end of the supporting component is disposed between the first groove and the second groove.

Wherein, the tilt angle threshold value is between 5 degrees and 30 degrees.

Wherein, the pelvic tilt detecting chair further comprises an alarm disposed on the carrying component and connected to the detector. The alarm is configured to receive the warning signal generated by the detector and generate an alarm message according to the warning signal.

Wherein, the detector is one selected from a group consisting of triaxial accelerometer, gyroscope sensor, pressure sensor and triaxial magnetometer.

Wherein, the carrying component comprises a first carrying portion and a second carrying portion. The first carrying portion and the second carrying portion are disposed opposite to each other and respectively comprise a first chair surface and a second chair surface. The pelvis of the user comprises a left ischial tuberosity and a right ischial tuberosity. When the user sits on the carrying component, the first chair surface and the second chair surface respectively contact the left ischial tuberosity and the right ischial tuberosity.

Wherein, the shape of the chair surface of the carrying component corresponds to the shape of the pelvis of the user.

In summary, the pelvic tilt detecting chair of the present invention can detect the actual pelvic angle of the pelvis of the user when the user is in a sitting position through the carrying component and the detector that are attached to the buttocks of the human body. The pelvic tilt detecting chair of the present invention can alert the user of the sitting posture in various warning ways, so as to avoid bad posture and maintain the correct posture.

### BRIEF DESCRIPTION OF THE APPENDED DRAWINGS

Some of the embodiments will be described in detail, with reference to the following figures, wherein like designations denote like members, wherein:

FIG. 1 shows a schematic diagram of one embodiment of a simple structure of a pelvic tilt detecting chair of the present invention.

FIG. 2 shows a schematic diagram of the embodiment of the simple structure of the pelvic tilt detecting chair of the present invention in FIG. 1 at different viewing angles.

FIG. 3A shows a schematic side view of the user sitting on the pelvic tilt detecting chair.

FIG. 3B shows a schematic back view of the user sitting on the pelvic tilt detecting chair.

FIG. 4A shows a schematic diagram of one embodiment of the pelvic tilt detecting chair of the present invention.

FIG. 4B shows a schematic diagram of one embodiment of the pelvic tilt detecting chair of the present invention.

FIG. 5A shows a schematic diagram of one embodiment of the pelvic tilt detecting chair of the present invention.

FIG. 5B shows a schematic diagram of one embodiment of the pelvic tilt detecting chair of the present invention.

FIG. 6 shows a schematic diagram of one embodiment of the pelvic tilt detecting chair of the present invention and a mobile device.

FIG. 7 shows a schematic diagram of one embodiment of a simple structure of a pelvic tilt detecting chair of the present invention.

FIG. 8 shows a schematic diagram of another embodiment of a simple structure of a pelvic tilt detecting chair of the present invention.

The advantages, spirits, and features of the present invention will be explained and discussed with embodiments and figures as follows.

### DETAILED DESCRIPTION OF THE INVENTION

A detailed description of the herein after described embodiments of the disclosed apparatus and method are presented herein by way of exemplification and not limitation with reference to the Figures. Although certain embodiments are shown and described in detail, it should be understood that various changes and modifications can be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention.

In the description of the present specification, the terminologies “in an embodiment”, “in another embodiment”, or “in some embodiments” means that the specific feature, structure, material or characteristic of the present embodiment is involved in at least one embodiment of the present invention. In the description of the present specification, the schematic representation of the mentioned terminologies does not necessarily refer to the same embodiment. Furthermore, the described specific feature, structure, material or characteristic can be involved in any one or more embodiments in a proper way.

In the description of the present invention, it should be understood that the orientation or positional relationship indicated by the terms “longitudinal, horizontal, upper, lower, front, rear, left, right, top, bottom, inner, outer” and the like is based on the orientation or positional relationship shown in the drawings. It is only for the convenience of describing the present invention and simplifying the description, rather than indicating that the described devices or elements must have a particular orientation, be constructed and operate in a particular orientation, and therefore should not be construed as a limitation of the present invention.

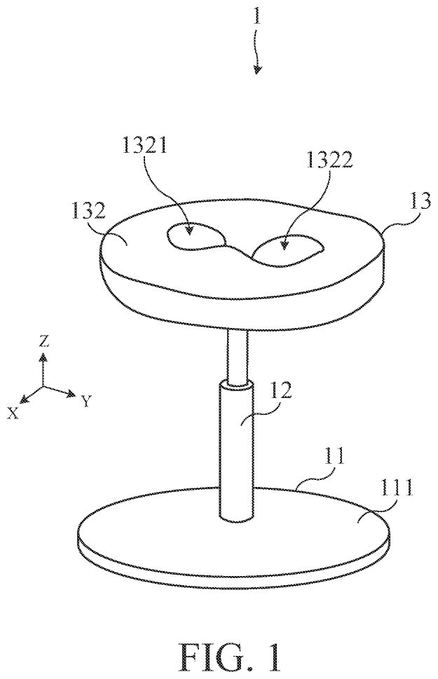

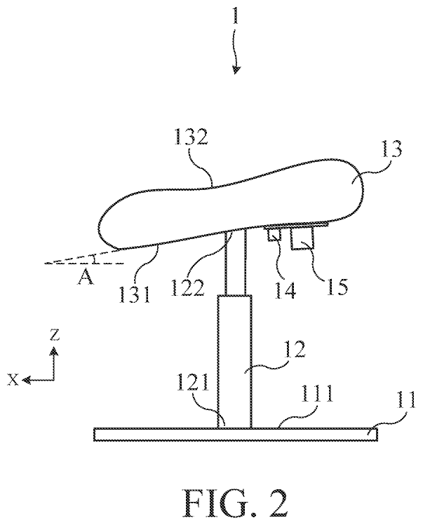

Please refer to FIG. 1 and FIG. 2. FIG. 1 shows a schematic diagram of one embodiment of a simple structure of a pelvic tilt detecting chair 1 of the present invention. FIG. 2 shows a schematic diagram of the embodiment of the simple structure of the pelvic tilt detecting chair 1 of the present invention in FIG. 1 at different viewing angles. As shown in FIG. 1 and FIG. 2. In this embodiment, the pelvic tilt detecting chair 1 comprises a base 11, a supporting component 12 and a carrying component 13. The base 11 comprises a horizontal surface 111. The supporting component 12 comprises a first end 121 and a second end 122 opposite to the first end 121. The first end 121 of the supporting component 12 is connected to the base 11. The carrying component 13 comprises an installing surface 131 and a chair surface 132 opposite to the installing surface 131. The installing surface 131 of the carrying component 13 is coupled to the second end 122 of the supporting component 12, and the chair surface 132 of the carrying component 13 is configured for a user to sit on.

In practice, the base 11 can be arranged on the ground, and the shape of the base 11 can be the disk shape shown in FIG. 1, but not limited thereto. The base 11 may also be in the form of a plurality of chair legs. Further, the base 11 may also include rollers. The horizontal surface 111 of the base 11 may be a plane where the base 11 and the ground are in contact with each other, or may be any plane where the base 11 and the ground are parallel to each other. The supporting component 12 is disposed on the base 11 and is configured for connecting the base 11 and supporting the carrying component 13. In this embodiment, the supporting component 12 is a cylindrical rod. In practice, the cross-sectional shape of the supporting component 12 can also be a square, a rectangle or any other shape. In addition, the supporting component 12 can be a telescopic rod for adjusting the height of the carrying component 13, so as to be suitable for users of different ages or heights. The first end 121 of the supporting component 12 can be fixed on the base 11 in a locking manner. In practice, it is not limited to this, and the base 11 and the supporting component 12 can also be integrally formed.

In this embodiment, the second end 122 of the supporting component 12 opposite to the first end 121 is configured to connect and support the carrying component 13. In practice, the second end 122 of the supporting component 12 may further include a swinging member (eg, a universal joint, a fisheye joint, a spring, etc.), and the installing surface 131 of the carrying component 13 may be connected to the swinging member. Therefore, the carrying component 13 can swing circumferentially with the second end 122 of the supporting component 12 as a fulcrum. As shown in FIG. 1 and FIG. 2. In this embodiment, the carrying component 13 of the pelvic tilt detecting chair 1 can swing back and forth along the direction of the X axis. Further, when the carrying component 13 swings, the chair surface 132 of the carrying component 13 and the horizontal surface 111 of the base 11 form a tilt angle A.

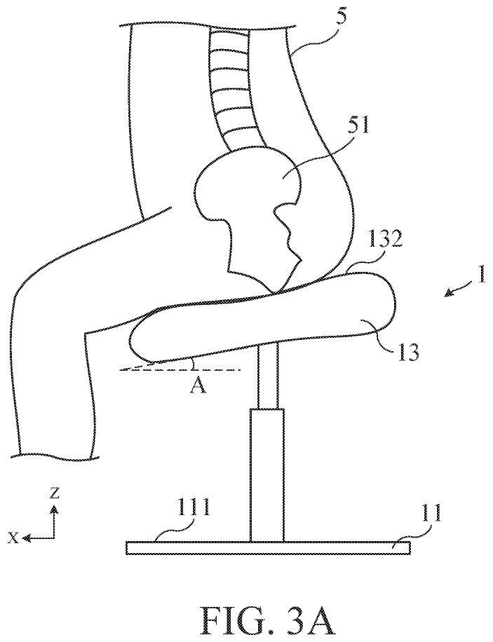

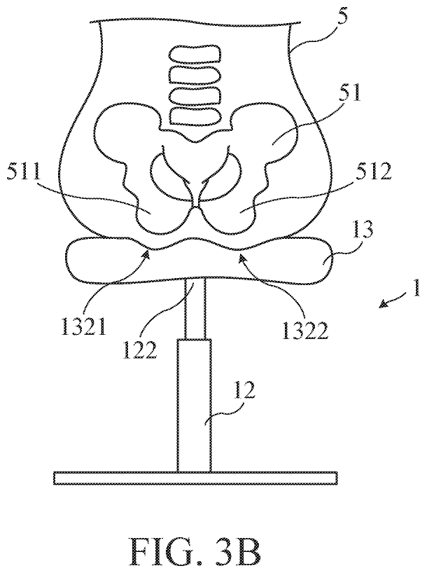

Please refer to FIG. 1, FIG. 2, FIG. 3A and FIG. 3B. FIG. 3A shows a schematic side view of the user 5 sitting on the pelvic tilt detecting chair 1. FIG. 3B shows a schematic back view of the user 5 sitting on the pelvic tilt detecting chair 1. As shown in FIG. 1, FIG. 3A and FIG. 3B. In this embodiment, the chair surface 132 of the carrying component 13 comprises a first groove 1321 and a second groove 1322. In practice, the pelvis 51 of the user 5 comprises a left ischial tuberosity 511 and a right ischial tuberosity 512. The positions of the first groove 1321 and the second groove 1322 of the chair surface 132 respectively correspond to the position of the left ischial tuberosity 511 and the right ischial tuberosity 512 of the user 5. In addition, the shape of the chair surface 132 may correspond to the shape of the pelvis 51 of the user 5. Therefore, when the user 5 sits on the pelvic tilt detecting chair 1, the chair surface 132 of the carrying component 13 can be closely attached to the buttocks of the user 5. The first groove 1321 and the second groove 1322 of the chair surface 132 can accommodate the left ischial tuberosity 511 and the right ischial tuberosity 512 of the pelvis 51 of the user 5. In practice, when the user 5 is in a sitting position, the pelvis 51 of the user 5 has a pelvic angle of the pelvis. Since the chair surface 132 of the carrying component 13 is closely attached to the pelvis 51 of the user 5, when the user 5 sits on the pelvic tilt detecting chair 1, the carrying component 13 of the pelvic tilt detecting chair 1 will swing according to the pelvic angle of the pelvis 51 of the user 5. That is to say, the tilt angle A formed between the chair surface 132 of the carrying component 13 and the horizontal surface 111 of the base 11 corresponds to the pelvic angle of the pelvis 51 of the user 5.

Further, the second end 122 of the supporting component 12 is located between the first groove 1321 and the second groove 1322. In practice, the supporting component 12 may also be located at the center of the carrying component 13. Therefore, when the user 5 sits on the pelvic tilt detecting chair 1, the supporting component 12 can balance the weight of the left ischial tuberosity 511 and the right ischial tuberosity 512.

In this embodiment, the pelvic tilt detecting chair 1 of the present invention further comprises a detector 14 disposed on the carrying component 13 and configured to detect the tilt angle A. In practice, the detector 14 can be three-axis accelerometer, gyroscope sensor, pressure sensor or three-axis magnetometer, but not limited to this. The detector 14 may also be six-axis sensor or nine-axis sensor formed by at least two of three-axis accelerometer, gyroscope sensor, pressure sensor, and three-axis magnetometer. The detector 14 can be integrated on the circuit board, and the detector 14 can be disposed on the installing surface 131 of the carrying component 13, but not limited thereto. The detector 14 can also be disposed inside the carrying component 13. When the user 5 sits on the carrying component 13 of the pelvic tilt detecting chair 1, the carrying component 13 will swing according to the pelvic angle of the pelvis 51 of the user 5 in the sitting position. The detector 14 disposed on the carrying component 13 also swings with the carrying component 13. At this time, the detector 14 detects the tilt angle A of the carrying component 13 caused by the swing, and the tilt angle A measured by the detector 14 is the pelvic angle of the pelvis 51 of the user 5.

Further, the detector 14 may store a tilt angle threshold value. When the tilt angle A measured by the detector 14 does not meet the tilt angle threshold value, the detector 14 generates a warning signal. In practice, when the human body is standing or sitting, the correct pelvic position is in a slightly forward tilted state, and the forward tilt angle of the pelvis is between 7 degrees and 19 degrees. Therefore, the tilt angle threshold value may be between 5 degrees and 30 degrees. When the tilt angle A measured by the detector 14 is less than 5 degrees or greater than 30 degrees, it means that the pelvic angle of the pelvis 51 of the user 5 in the sitting position is in an incorrect angle range. That is, the user 5 sits on the pelvic tilt detecting chair 1 in a bad sitting posture. At this time, the detector 14 generates a warning signal.

In addition, in this embodiment, the pelvic tilt detecting chair 1 of the present invention further comprises an alarm 15 disposed on the carrying component 13 and connected to the detector 14. The alarm 15 is configured for receiving the warning signal generated by the detector 14 and generating the alarm message according to the warning signal. In practice, the alarm 15 can be light bulb, LED light, buzzer, vibrator, etc., and the alarm message can be light, sound, image, text, vibration, and the like. For example, the alarm 15 can be a light bar which is arranged around the carrying component 13 of the pelvic tilt detecting chair 1. When the detector 14 detects that the tilt angle A does not meet the tilt angle threshold value and generates a warning signal, the alarm 15 emits a red light. The user can adjust the sitting posture through the red-light bar, so that the pelvis of the user is in the correct position.

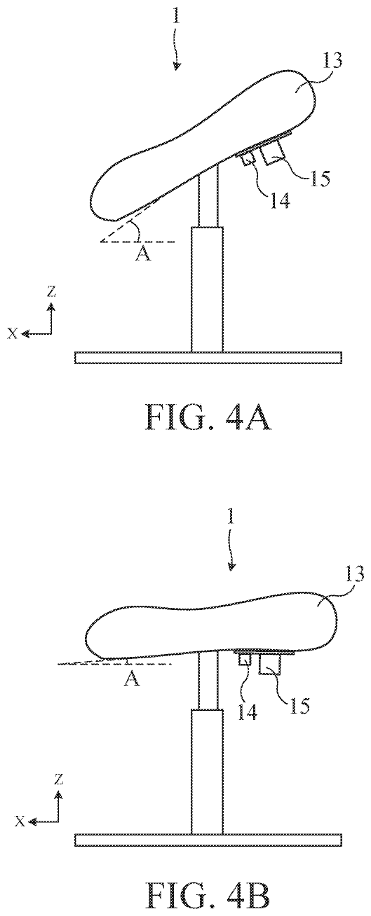

Please refer to FIG. 4A and FIG. 4B. FIG. 4A shows a schematic diagram of one embodiment of the pelvic tilt detecting chair 1 of the present invention. FIG. 4B shows a schematic diagram of one embodiment of the pelvic tilt detecting chair 1 of the present invention. As shown in FIG. 4A, when the user sits on the pelvic tilt detecting chair 1 and the pelvis of the user is too tilted forward, the pelvis of the user drives the carrying component 13 to swing forward (ie, the +X direction in the figure). Further, when the tilt angle of the pelvis of the user to forward is greater than the tilt angle threshold value, the tilt angle A measured by the detector 14 is also greater than the tilt angle threshold value, thereby generating a warning signal. Then, the alarm 15 sends out the alarm message according to the warning signal generated by the detector 14. Similarly, as shown in FIG. 4B, when the user sits on the pelvic tilt detecting chair 1 and the pelvis of the user is too tilted backward, the pelvis of the user drives the carrying component 13 to swing backward (ie, −X direction in the figure). Further, when the tilt angle of the pelvis of the user to forward is smaller than the tilt angle threshold value, the tilt angle A measured by the detector 14 is also smaller than the tilt angle threshold value, thereby generating a warning signal. Then, the alarm 15 sends out the alarm message according to the warning signal generated by the detector 14.

In practice, when the pelvis of the user is too tilted forward, the lumbar vertebrae connected to the pelvis will bend forward excessively and be in a tight state, resulting in abnormal physiological lordosis of the lumbar vertebrae, which in turn causes low back pain. In addition, the vertebrae which are attached to the lumbar spine, are also deformed. If the pelvis is too tilted forward for a long time, the structure of the organs of the stomach will change, and the lower abdomen will bulge abnormally, even destroying the body curve. When the pelvis of the user is too tilted backward, the lumbar vertebrae connected to the pelvis will drive the vertebrae to bend backwards, resulting in a kyphosis. Therefore, the pelvic tilt detecting chair 1 of the present invention uses the detector to detect the pelvic angle of the user in the sitting posture, and can remind the user of the sitting posture through the alarm, so as to avoid poor posture and maintain a correct posture.

In addition to detecting whether the pelvis of the user is tilted forward or backward, the pelvic tilt detecting chair of the present invention can also detect tilt in other directions. In an embodiment, the carrying component of the pelvic tilt detecting chair can swing left and right along the direction of the Y axis. When the carrying component swings, the chair surface of the carrying component forms a lateral tilt angle with the horizontal surface of the base. Further, the detector can also store the lateral tilt angle threshold value and measure the lateral tilt angle of the carrying component, so as to detect whether the pelvis of the user is tilted left and right when the user is sitting. In another embodiment, the carrying component of the pelvic tilt detecting chair can swing along any direction on the X-Y plane. When the carrying component swings, the chair surface of the carrying component forms a tilt angle with the horizontal surface of the base. Further, the detector can also store the tilt angle thresholds value in each direction and use it to measure the tilt angle of the carrying component, so as to detect whether the pelvis of the user is excessively tilted in each direction when the user is sitting.

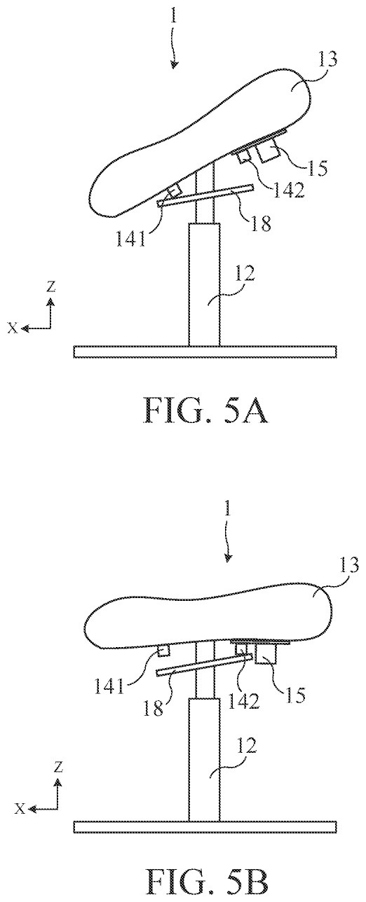

The pelvic tilt detecting chair of the present invention can also be configured in other ways for detecting the tilt angle. Please refer to FIG. 5A and FIG. 5B. FIG. 5A shows a schematic diagram of one embodiment of the pelvic tilt detecting chair 1 of the present invention. FIG. 5B shows a schematic diagram of one embodiment of the pelvic tilt detecting chair 1 of the present invention. The difference between this embodiment and the previous embodiments is that the pelvic tilt detecting chair 1 of this embodiment further comprises a limiting plate 18, and the detector further comprises a first detector 141 and a second detector 142. The limiting plate 18 is disposed on the supporting component 12. The first detector 141 and the second detector 142 are respectively disposed on two sides of the supporting component 12 and located in the forward and backward swinging direction (ie, the X-axis direction). In practice, the first detector 141 and the second detector 142 are pressure sensors. The limiting plate 18 may be disposed on the supporting component 12 according to the tilt of the carrying component 13. As shown in FIG. 5A, when the user sits on the pelvic tilt detecting chair 1 and the pelvis of the user is too tilted forward, the pelvis of the user drives the carrying component 13 to swing forward (ie, the +X direction in the figure). When the first detector 141 contacts the limiting plate 18, the first detector 141 generates a warning signal. On the contrary, as shown in FIG. 5B, when the user sits on the pelvic tilt detecting chair 1 and the pelvis of the user is too tilted backward, the pelvis of the user drives the carrying component 13 to swing backward (ie, the −X direction in the figure). When the second detector 142 contacts the limiting plate 18, the second detector 142 generates a warning signal. Please note that the number and arrangement positions of the detectors are not limited to those shown in FIG. 5A and FIG. 5B, and the number of the detectors can also be four or more. In an embodiment, the detector further comprises a third detector and a fourth detector, and the third detector and the fourth detector are respectively disposed on both sides of the support rod support and in the left and right swing directions, and are configured to detect whether the pelvis of the user is tilted left and right.

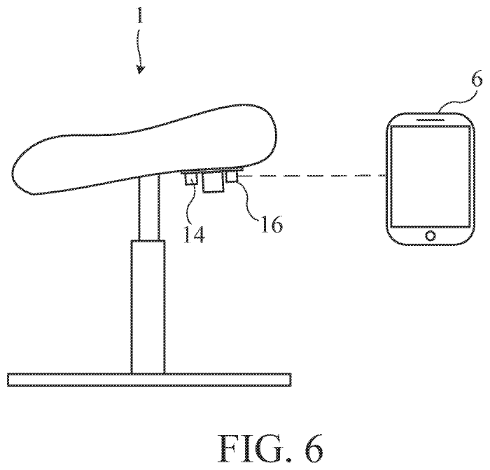

The pelvic tilt detecting chair of the present invention can not only remind the user of poor sitting posture through the alarm, but also remind the user through other means. Please refer to FIG. 6. FIG. 6 shows a schematic diagram of one embodiment of the pelvic tilt detecting chair 1 of the present invention and a mobile device 6. The difference between this embodiment and the aforementioned embodiments is that the pelvic tilt detecting chair 1 of this embodiment further comprises a transmitting module 16. The transmitting module 16 is connected to the detector 14 and a mobile device 6. The transmitting module 16 is configured for receiving the warning signal generated by the detector 14 and transmitting the warning signal to the mobile device 6. In practice, the transmitting module 16 can be a signal transceiver and can be integrated on a circuit board. The mobile device 6 can be mobile phone, computer, tablet computer, or the like. When the detector 14 detects that the tilt angle does not meet the tilt angle threshold value and generates the warning signal, the transmitting module 16 can transmit the warning signal to the mobile device 6 by wireless transmission. Then, the mobile device 6 can generate a prompt tone of the mobile phone according to the warning signal or display the message “Poor sitting posture, the pelvis is too tilted forward”, etc., to remind the user to adjust the sitting posture so that the pelvis of the user is in the correct position. In addition, the detector 14 can also transmit the current tilt angle to the mobile device 6 through the transmitting module 16. Therefore, the user can check the current tilt angle when sitting on the pelvic tilt detecting chair 1 through the mobile device 6.

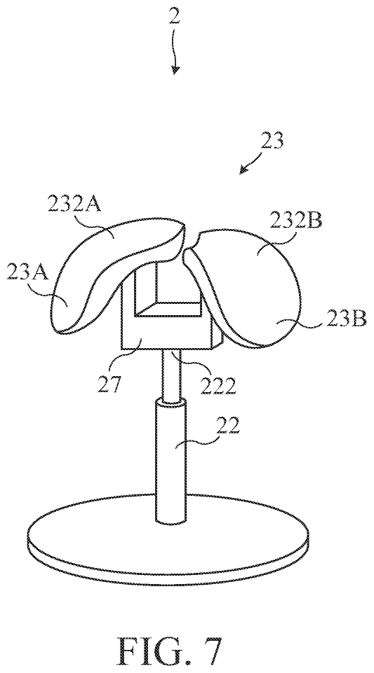

The pelvic tilt detecting chair of the present invention can be in addition to the mode of the aforementioned embodiment, and can also be in other modes. Please refer to FIG. 7. FIG. 7 shows a schematic diagram of one embodiment of a simple structure of a pelvic tilt detecting chair 2 of the present invention. As shown in FIG. 7, the difference between this embodiment and the aforementioned embodiments is that the carrying component 23 of the pelvic tilt detecting chair 2 of this embodiment further comprises a first carrying portion 23A and a second carrying portion 23B. The first carrying portion 23A and the second carrying portion 23B are disposed opposite to each other and comprise a first chair surface 232A and a second chair surface 232B, respectively. In practice, when the user sits on the pelvic tilt detecting chair 2, the left ischial tuberosity and the right ischial tuberosity of the user are respectively seated and contacted on the first chair surface 232A and the second chair surface 232B. The first carrying portion 23A and the second carrying portion 23B can be connected to a connecting member 27, and the connecting member 27 is movably disposed on the supporting component 22. Therefore, the carrying portion 23 can swing through the connecting member 27 with the second end 222 of the supporting component 22 as a fulcrum.

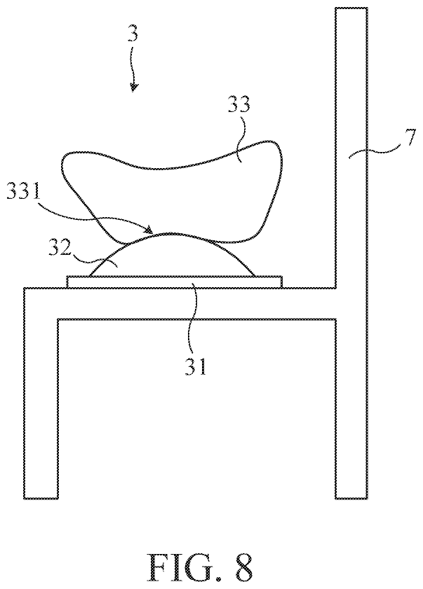

Please refer to FIG. 8. FIG. 8 shows a schematic diagram of another embodiment of a simple structure of a pelvic tilt detecting chair 3 of the present invention. As shown in FIG. 8, the difference between this specific embodiment and the aforementioned embodiments is that the supporting component 32 of the pelvic tilt detecting chair 3 of this embodiment is an arc structure, and the shape of the installing surface 331 of the carrying component 33 corresponds to the shape of the supporting component 32. In addition, the base 31 of the pelvic tilt detecting chair 3 of this embodiment can be disposed on a chair 7. When the user sits on the pelvic tilt detecting chair 3, the installing surface 331 of the carrying component 33 can move along the surface of the supporting component 32 along with the tilt of the pelvis of the user, so that the carrying component 33 is swung around the supporting component 32 as a fulcrum.

In summary, the pelvic tilt detecting chair of the present invention can detect the actual pelvic angle of the pelvis of the user when the user is in a sitting position through the carrying component and the detector that are attached to the buttocks of the human body. The pelvic tilt detecting chair of the present invention can remind the user of the sitting posture in various warning ways, so as to avoid bad posture and maintain the correct posture.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A pelvic tilt detecting chair, configured for a user to sit thereon and to detect a pelvic angle of the pelvis of the user in sitting position, the pelvic tilt detecting chair comprising:
a base comprising a horizontal surface;
a supporting component comprising a first end and a second end opposite to the first end, and the first end being connected to the base;
a carrying component moveably disposed on the supporting component and configured to carry the pelvis of the user, the carrying component comprising an installing surface and a chair surface opposite to the installing surface, the installing surface being coupled to the second end of the supporting component, causing the carrying component to swing with the second end as a fulcrum, the chair surface being configured to contact the pelvis, a tilt angle being formed between the chair surface and the horizontal surface of the base when the user sits on the carry component, wherein the tilt angle corresponds to the pelvic angle of the user; and
a detector disposed on the carrying component, the detector being configured to detect the tilt angle and store a tilt angle threshold value, wherein the detector generates a warning signal when the tilt angle does not match up with the tilt angle threshold value.

2. The pelvic tilt detecting chair of claim 1, wherein the chair surface of the carrying component comprises a first groove and a second groove, and the pelvis of the user comprises a left ischial tuberosity and a right ischial tuberosity, when the user sits on the carrying component, the first groove and the second groove respectively accommodate the left ischial tuberosity and the right ischial tuberosity.

3. The pelvic tilt detecting chair of claim 2, wherein the second end of the supporting component is disposed between the first groove and the second groove.

4. The pelvic tilt detecting chair of claim 1, wherein the tilt angle threshold value is between 5 degrees and 30 degrees.

5. The pelvic tilt detecting chair of claim 1, further comprising an alarm disposed on the carrying component and connected to the detector, the alarm being configured to receive the warning signal generated by the detector and generate an alarm message according to the warning signal.

6. The pelvic tilt detecting chair of claim 1, further comprising a transmitting module connected to the detector and a mobile device, the transmitting module being configured to receive the warning signal generated by the detector and transmit the warning signal to the mobile device.

7. The pelvic tilt detecting chair of claim 1, wherein the detector is one selected from a group consisting of triaxial accelerometer, gyroscope sensor, pressure sensor and triaxial magnetometer.

8. The pelvic tilt detecting chair of claim 1, wherein the carrying component comprises a first carrying portion and a second carrying portion, the first carrying portion and the second carrying portion are disposed opposite to each other and respectively comprise a first chair surface and a second chair surface, the pelvis of the user comprises a left ischial tuberosity and a right ischial tuberosity, when the user sits on the carrying component, the first chair surface and the second chair surface respectively contact the left ischial tuberosity and the right ischial tuberosity.

9. The pelvic tilt detecting chair of claim 1, wherein the shape of the chair surface of the carrying component corresponds to the shape of the pelvis of the user.
